(19) United States
(12) Patent Application Publication
(10) Pub. No.: US 2003/0210226 A1
(43) Pub. Date: Nov. 13, 2003

(54) System, method, and computer program product for tracking electronic book reading pattern

(75) Inventors: Seng Beng Ho, Singapore (SG); Chern Hway Seet, Singapore (SG)

Correspondence Address: OBLON, SPIVAK, MCCLELLAND, MAIER & NEUSTADT, P.C., 1940 DUKE STREET, ALEXANDRIA, VA, 22314, US

(73) Assignee: E-BOOK SYSTEMS PTE LTD., Singapore (SG)

(21) Appl. No.: 10/390,657

(22) Filed: Mar. 19, 2003

Related U.S. Application Data
(60) Provisional application No. 60/367,765, filed on Mar. 28, 2002.
(60) Provisional application No. 60/365,186, filed on Mar. 19, 2002.

(51) Int. Cl. G09G 5/00

(52) U.S. Cl. 345/156

(57) ABSTRACT

An information processing system including a computer software combined with a computer or television screen under software and hardware control for the purpose of browsing through documents stored in a computer. Specifically, a method by which the reading pattern of a reader browsing or reading the information provided on the computer screen can be monitored and analyzed.

### CROSS REFERENCE TO RELATED PATENT DOCUMENTS

This application is related to the following co-pending patent applications all of which are incorporated herein by reference: application Ser. No. 60/365,186 filed on Mar. 19, 2002; application Ser. No. 60/367,765 filed on Mar. 28, 2002; application Ser. No. 60/410,278 filed on Sep. 13, 2002; application Ser. No. 10/142,996 filed on May 13, 2002; application Ser. No. 10/142,858 filed on May 13, 2002; application Ser. No. 10/143,005 filed on May 13, 2002; application Ser. No. 09/686,965 filed on Oct. 12, 2000; application Ser. No. 10/283,084 filed on Oct. 30, 2002; application Ser. No. 09/686,902 filed on Oct. 12, 2000; application Ser. No. 09/617,043 filed on Jul. 14, 2000; application Ser. No. 10/052,387 filed on Jan. 23, 2002; and application Ser. No. 10/029,868 filed on Dec. 13, 2001. This application is also related to the following patents, all of which are incorporated by reference: U.S. Pat. No. 5,909,207 issued Jun. 1, 1999; U.S. Pat. No. 6,064,384 issued May 16, 2000; U.S. Pat. No. 6,340,980 issued Jan. 22, 2002; and U.S. Pat. No. 6,407,757 issued Jun. 18, 2002.

### BACKGROUND OF THE INVENTION

1. Field of the Invention

The present invention relates to an information processing system including a computer software combined with a computer or television screen under software and hardware control for the purpose of browsing through documents stored in a computer. Specifically, the present invention provides a method by which the reading pattern of a reader browsing or reading the information provided on the computer screen can be kept track of and analyzed.

2. Description of the Prior Art

Currently, the method for viewing documents stored in a computer is through a computer monitor screen. For documents that are longer/larger than can be contained within one screen, a capability is provided to scroll the document up and down or to jump to a particular point in the document (through the use of, for example, a “mouse” coupled with scroll bars at the edges of the document displayed on the screen or through the use of hypertext links).

However, most people do not find this a particularly convenient way to view a document, as compared with a book. That this is true is evidenced in the fact that despite the fact that the computer has been in increasing use, there is not only no corresponding reduction in paper use, but an increase in paper quantity is required to print what is conveniently stored in a computer that can be seemingly easily and flexibly manipulated for viewing. Sometimes the printed version of the information involved is necessary, like in the case of printing a picture on a sheet of paper to be pasted on some surface (e.g., a wall), or in the case of the convenience of having a relatively light, hardy paperback book for reading in almost any possible situation and location, but there are times when a reader is quite happy to sit at a desk in front of a desktop computer or handle a notebook computer away from the desk, and yet the reader would still prefer a printed version of the document in a hand-held format. This is especially true in the case of looking through manuals, including software manuals, to understand how to operate a device or software application. The irony is that computer software packages usually come with thick and heavy manuals containing information which can easily be stored on a light-weight CD-ROM, and even if the manuals are sometimes dispensed in the form of a CD-ROM, more often than not people would print them out into a hard-copy format in order to facilitate reading.

What is involved when one interacts with the printed material in a book is a subtle and complicated process. To start with, material in a book is presented in a sequential order, with a continuity of material from page to page, and there is also a hierarchical structure in the material presented (as the material is organized into chapters, sections, subsections, etc.) because ideas in the material are related to each other in some kind of conceptual hierarchy. The human perceptual system inputs data in a sequential manner, and after a book is read from the beginning to the end in a sequential fashion, the brain then recreates the conceptual hierarchy after viewing the material involved. However, very often one does not read a book (or input the material involved) from the beginning to the end because (a) one wants to have an overview of the material present; (b) one is searching for something of interest to him/her; or (c) one is interested in reading only portions of the book (in the case of, say, reading the manual to understand how to operate something). In these cases, one browses through the subject book to find the material of unique interest to that reader.

Two basic things are achieved in the browsing process. First, the browser has a glimpse of what are the contents of the book document. Second, the browser has an idea of approximately where the items of interest are so that the browser can (a) return to look for them later when needed, and (b) have an understanding of the relationships between the material currently being viewed and other material (i.e., an understanding of the hierarchical structure involved). When browsing a book document, many finger-operations are required of the browser in order to flip through the pages and, together with the inherent sequential order imposed by the pages, very quickly allow the browser to have an understanding of the nature, location and organization of the material involved.

In the process of browsing through a book, one can perform the following operations:

(a) flip through the pages at varying speeds depending on the level of detail at which one wishes to view the material in the book;

(b) jump to the approximate location of the item of interest;

(c) change the direction of flipping (forward or backward) very rapidly because

(i) one would like to compare and contrast material on different pages,

(ii) after jumping to an approximate location of some items of interest one would like to find their exact locations, or

(iii)one is unsure of where the item of interest is and is in the process of searching for it; and

(d) mark the locations of some pages of interest that one may want to later return.

All these operations are performed very rapidly with the fingers interacting with the flipping pages and with minimal unnecessary movements of the fingers and hands. Interestingly, a book/magazine with soft and flexible pages is harder to handle because more finger and hand movements are needed to browse through it, while books with stiff pages can be browsed with almost no movement of the hand.

In currently available methods of browsing through documents stored in a computer, e.g., the use of a mouse combined with scroll bars and buttons on the computer screen, more movements of the hands are necessary to effect the various operations described above. Also, fine control of the hand or fingers (depending on whether the mouse uses hand movement to move the cursor on the screen or finger movement like in the case of a track ball) is necessary to position the cursor on the screen at the required places. The process is both lengthy and clumsy. The lengthiness of the process taxes the ability of the human short term memory to remember items encountered in the recent past for the purpose of establishing the relationships between items, and the clumsiness of the process creates distraction and interferes with the short term memory process, a well known effect in perceptual psychology.

Because material in a book is organized into pages, it also enhances the ability of the reader to better remember the location of various portions of the material involved. Also, unlike the process of scrolling through a document on a screen like what is normally done in a word-processor, wherein the contents become a blur and reading is impossible, when one moves through the material in a book through flipping, one is still able to read at least the approximate contents, if not the details. It is due to these features that a person browsing through a book can acquire a good understanding of its contents, the location of specific items and organization of the material.

It is because of the reasons set forth above, people still prefer to read a book in their hands, rather than a document image displayed on a computer screen using currently available methods.

Similarly, the vast amount of information available on the Internet can benefit from the organizational structures normally found in a book—the sequential page-by-page organization of information. These organizational structures give rise to two major benefits: 1. navigational problems are greatly reduced—i.e., they allow the browser to know where he/she is, what other information exists, and how to get from one section of the information to another, and 2. a good overview of the included information becomes easily available.

U.S. Pat. No. 6,064,384 to Ho describes a computer-based interface that exploits a method for organizing information in a paper book. Basically, a virtual book is presented on the computer screen for the display of information. This virtual book simulates the paper book down to the last details—the flipping of pages, the representation of thicknesses on the sides of the book and the amount of thickness on the sides of the book being proportional to the amount of information residing on the respective sides, the ability to jump to any page in the virtual book by selecting the page on the thickness, etc.

However, the method of presenting information in a virtual book form described in U.S. Pat. No. 6,064,384 to Ho does not exploit the full potential of an electronic version of a paper book running on the computer. Basically, besides benefiting from the paper book paradigm in ways described above, the electronic virtual book should provide the mechanisms for monitoring the behavior of readers reading the virtual book. This information is of paramount importance for keeping track of and understanding reader behavior for the purpose of improving the layout and contents of the book. Another important application of this information is for understanding how readers absorb information on advertisements placed on the pages. This has potentially big implications for Internet advertising.

Therefore, the inventor has identified there exists a need for a mechanism that allows the reader's behavior while browsing a virtual book residing either on the hard disk or somewhere else on the Internet to be kept track of, so that this information may be used in subsequent analyses to benefit e-learning, e-advertisments, etc.

### SUMMARY OF THE INVENTION

In view of the aforementioned short-comings of presently available schemes for obtaining useful information from a virtual book displayed on a computer or television screen for the reading and browsing of information, one objective of the present invention is to provide a method for collecting, presenting and storing certain useful information on the reading pattern of a reader while browsing through a virtual book on a computer.

Another objective of the invention is to provide a method by which the information on the reading pattern is collected and sent to a displaying and analyzing software.

A further objective of the invention is to provide a method for collecting and transmitting information on the reading pattern to the level of specific parts on a page.

Yet a further objective of the invention is to provide a client/server protocol for the communication between the virtual book software on the client side and the server/analyzer software on the server side for the display and analysis of reading pattern data.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a top perspective view of an exemplary virtual book displayed on a computer or a television screen that is used to display information from the hard disk or downloaded from the Internet;

FIG. 1B is a top perspective view of the exemplary virtual book displayed on the computer screen during the process of jumping a number of pages ahead in the book;

FIG. 1C is a top perspective view of the exemplary virtual book displayed on the computer screen in the process of flipping to the next page;

FIG. 1D is a top perspective view of the exemplary virtual book displayed on the computer screen during the process of flipping many pages simultaneously;

FIG. 2A is a top perspective view of the exemplary virtual book just before the start of a browsing session before information is being downloaded into the book;

FIG. 2B is a sequence of top perspective views of the exemplary virtual book in the process of downloading some new information from the hard disk or the Internet in response to the entry of a URL;

FIG. 2C is a sequence of top perspective views of the exemplary virtual book in the process of downloading some new information into the book in response to the selection and activation of a hyperlink on the page of the exemplary virtual book;

FIG. 3 is a top perspective view of the exemplary virtual book showing various exemplary controls available on and around the exemplary virtual book to effect a number of operations associated with browsing information on the virtual book, including a “centerfold” mode of display of information;

FIG. 4 shows the various parts of a system by which the information on reading pattern when one browses a virtual book is collected, transmitted, displayed, analyzed, and stored;

FIG. 5 shows the raw data on the reading pattern that can be collected for subsequent display, storage and analyses;

FIG. 6 shows the process by which the raw data of FIG. 5 can be collected;

FIG. 7 shows the parts of a Server system that tracks user's access and use of virtual books;

FIG. 8 shows the Client/Server Protocol for Open Book Transaction;

FIG. 9 shows the Client/Server Protocol for Flipping Book Transaction;

FIG. 10 shows the Client/Server Protocol for Close Book Transaction; and

FIG. 11 illustrates an exemplary computer system programmed to perform one or more of the special purpose functions of the present invention.

### DESCRIPTION OF THE PREFERRED EMBODIMENTS

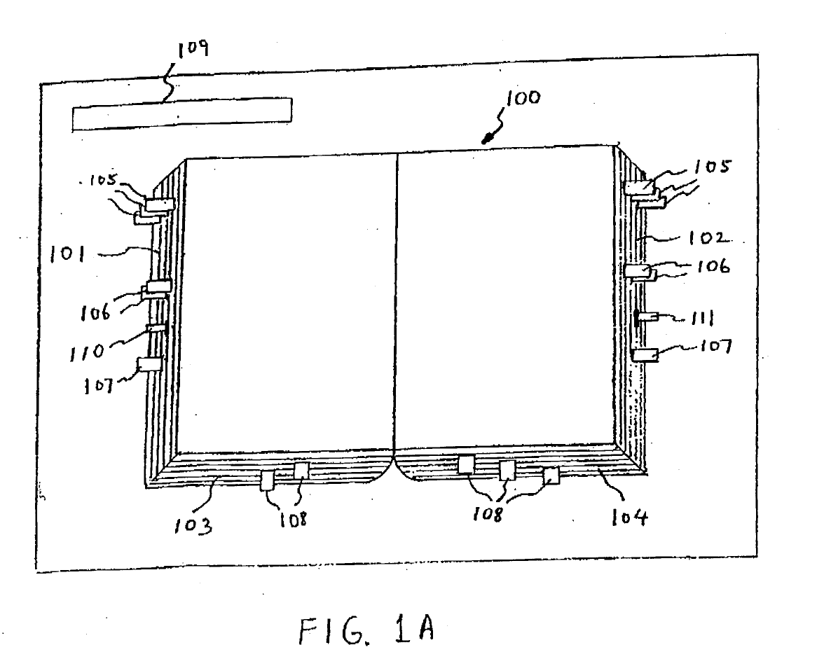

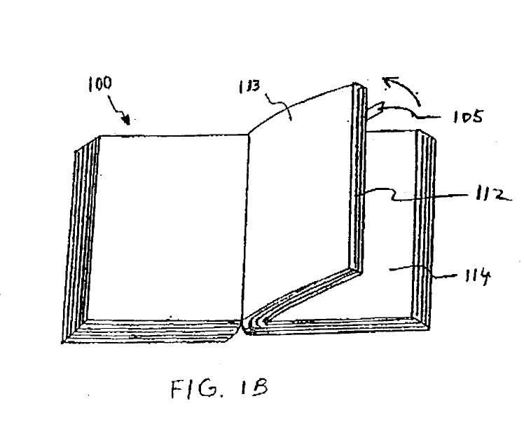

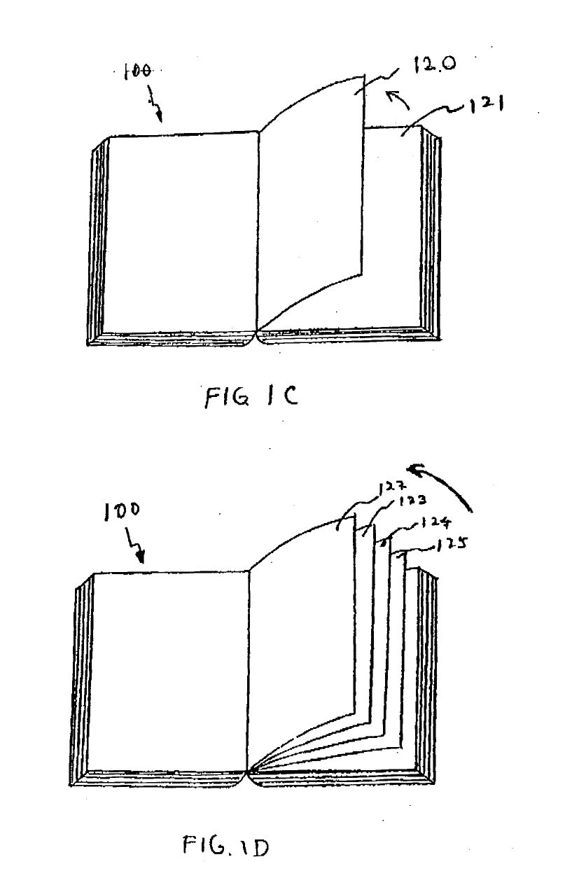

Referring now to the drawings, wherein like reference numerals designate identical or corresponding parts throughout the several views, and more particularly to FIG. 1A thereof which depicts one embodiment of a virtual book interface displayed on the computer screen. Basically, the information from the hard disk or downloaded from the Internet is displayed on two pages as in an opened book. At this stage, a number of pages have been browsed through and collected in the “virtual book” 100. The amount of material before and after the current pages (the pages in view) is shown as varying thicknesses on the left and right sides (101 and 102), respectively (as well as the left and right bottom edges (103 and 104)), of the book. On the left and right thicknesses (101 and 102) are shown a number of bookmarks (105-107) that bookmark some of the pages that have been viewed earlier. There are three types of bookmarks on these thicknesses. They are page-bookmarks 105, annotation bookmarks 106, and finger bookmarks 107. These will be explained shortly. On the bottom thicknesses (103 and 104) are shown a number of keyword bookmarks 108. A URL (Universal Resource Locator) field 109 above the browsing book 100 allows URL addresses to be entered. This URL can point to a location on the Internet or on the hard disk.

In order to allow the user to select any desired page, jump cursors 110 and 111 are provided on the left and right thickness (101 and 102). The user, using a mouse or other control, can move the left or right jump cursors (110 and 111 respectively) up and down the left or right thicknesses (101 and 102 respectively). The page number may appear on the tag of the jump cursor to display the page selected by the jump cursor. When the user has decided to jump to a certain page using the jump cursor to select that page, he/she can use the mouse or other input device to activate the jump.

FIG. 1B depicts the process by which a certain selected page in the browsing book 100 is jumped to. This jump may have been either activated by the selection of a bookmark (e.g. page-bookmark 105) or by the jump cursor (e.g., jump cursor 110 or 111). The thickness 112 between the page originally in view 113 and the page jumped to 114 is shown to move across the computer screen in continuous animation, much like in the case of the physical book.

FIG. 1C depicts a process by which one page 120 in the browsing book 100 is being flipped. The page 120 can be shown to bend and move across the computer screen to reveal the underlying page 121.

FIG. 1D depicts a process by which, because of increased speed of moving through the browsing book 100 by flipping the pages, more than one page (122-125) is shown to be moving across the computer screen at the same time. The user can select to freeze all the pages in motion.

As described in U.S. Pat. No. 6,064,384 to Ho, the virtual book 100 can be used to display documentary contents as well as used as an operating system interface.

Using commercially available computer hardware and software, one method of generating flipping pages from a document stored in semiconductor, magnetic, optical, or other media on a personal (e.g. laptop) computer in the form of a text file, such as a text file in the Windows 95 operating system involves several steps. First, the contents of the text file is displayed on the computer screen (such as an IBM Color Monitor G50, part Number 96G1593) using, for example, a word processing software application such as Microsoft® Word Version 7.0 from Microsoft Corporation, Part Number 62306 running on the computer. The image on the computer screen which is stored in the screen dump can then be put into the clipboard using the “Print Screen” key on the keyboard (such as an IBM Keyboard, Part Number 06H9742). The clipboard can be imported as an image file into a graphics software such as Visioneer PaperPort™ from Visioneer Communications, Inc. of Palo Alto, Calif., Part Number C1132-90000 running on the computer using the “Paste” command provided by the software, and then exported and stored as an image file in, say, the TIFF format. Each page in the document can be captured in this way in one TIFF file. Then, using a video editing/movie making software such as Adobe Premier™ 4.0 from Adobe Systems Incorporated of Mountain View, Calif., part Number 02970103 running on the computer, the TIFF files, each containing one page of the document, can be imported into the software and using the Motion command and superimposition facilities provided by the software a “movie” of flipping pages can be generated and if necessary, exported and stored in a motion picture format such as a .AVI file.

For the purpose of the present invention, the various components/operations described above for generating flipping pages from an existing document file using currently available software are preferably integrated into a single software process that may be conveniently ported from one computer to the next and which requires minimal human intervention. An alternative method reads from the existing document file directly, generates the necessary images for all the pages, and then creates a “motion picture” of flipping pages from these images. To move through the document forward or backward at any selected speed, mechanisms similar to forwarding or reversing at any selected speed when viewing a motion picture file (such as one in the AVI format) using a software video player (such as Video for Windows from Microsoft Corporation) are used.

While it is preferred to use off-the-shelf hardware and software to effect the flipping/flashing/scrolling/etc. effect, customized hardware and software can be used to perform an equivalent function.

The virtual book 100 (FIG. 1A) can be used to display contents from the hard disk or the Internet. The contents from the Internet or the hard disk can be of a fixed amount, in which case the virtual book 100 has a fixed amount of pages from the moment it is opened to the moment it is closed, or the contents can be added to or subtracted from the virtual book 100 as information is being obtained from the hard disk or the Internet in the browsing process or being deleted.

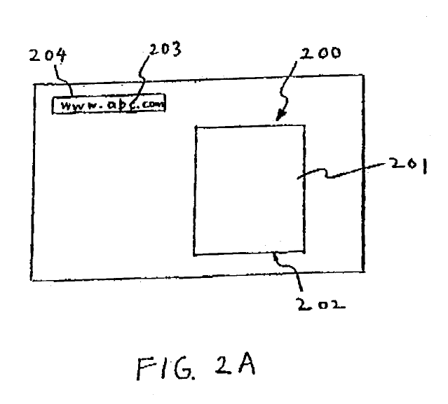

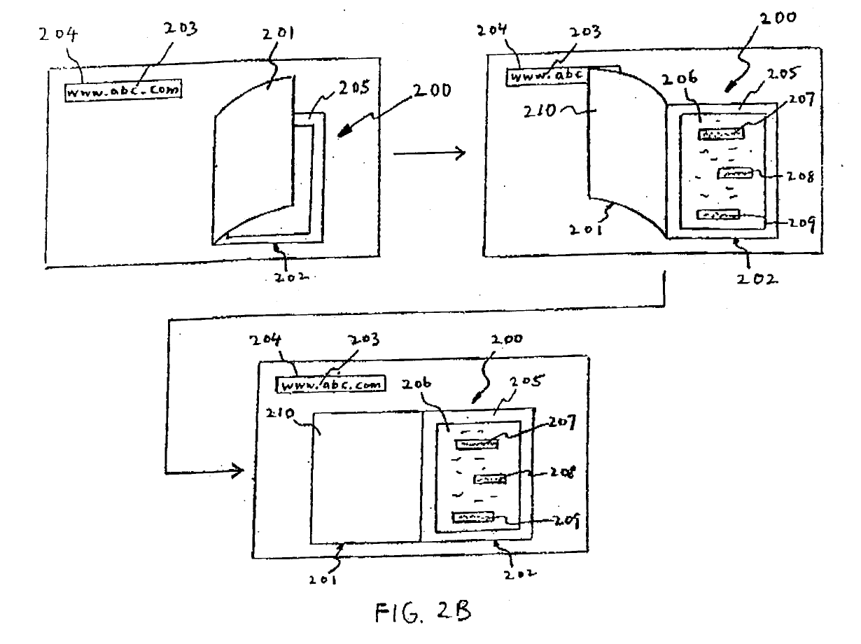

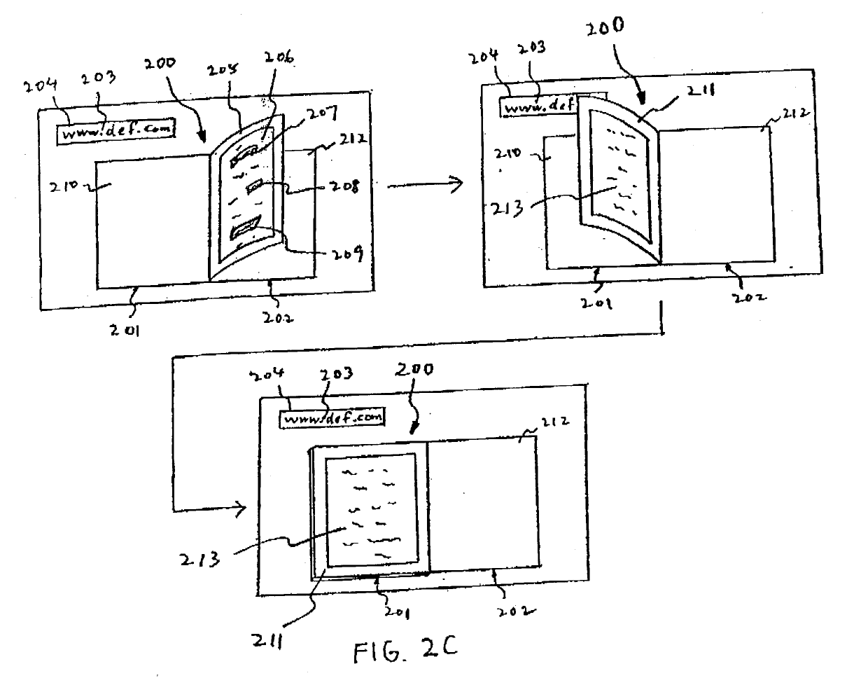

FIGS. 2A-2C depict example processes by which the virtual book 100 is created in a browsing process. FIG. 2A shows the beginning of a browsing process when a browsing session is launched. A book 200 is created and displayed. At this time the book consists only of the front cover 201 and back cover 202.

FIG. 2B depicts what can happen when a URL 203 (Universal Resource Locator —the address of a “Web page” or a page on the hard disk) is entered into the field 204 on the top of the display and activated. The front cover 201 of the virtual book 200 is flipped open, revealing a new page 205 in the book 200. On the new page 205, the page 206 of the URL 203 is displayed. The left hand page (210) is empty.

A number of hyperlinks (207-209) is available on the page 206. FIG. 2C depicts what happens when a hyperlink 207 on the page 206 (FIG. 2B) is selected and activated. The page 205 flips to reveal two more new pages(211 and 212) added to the virtual book 200. On the page 211 are the contents of the page 213 pointed to by the hyperlink 207 (FIG. 2B). The left side of the virtual book 200 now indicates a relatively small thickness because of the limited number of pages added to the left side. As more and more contents are brought into the virtual book 200, it would acquire increased thicknesses on both sides.

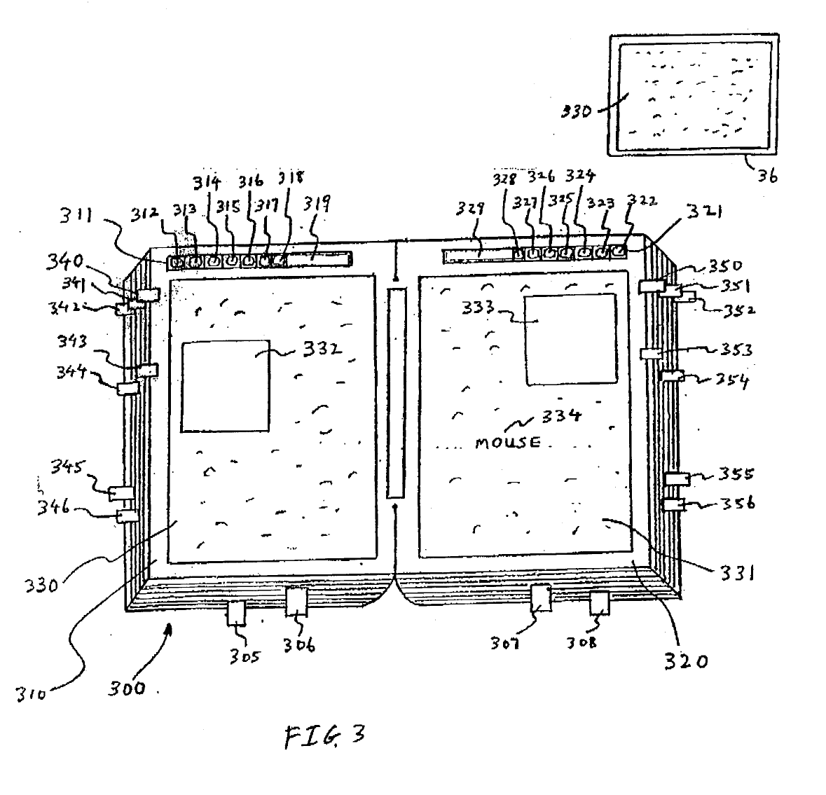

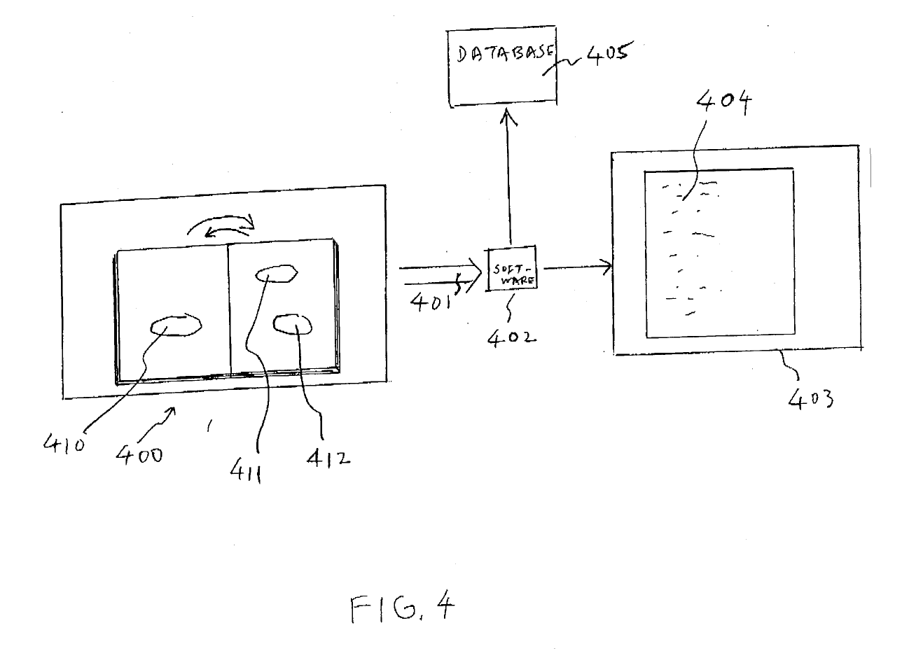

Because the virtual book 100 has many page-related operations, it would be more convenient to display a tool bar associated with each page (e.g., a tool bar 311 associated with the left hand page 310 and a tool bar 321 associated with the right hand page 320), as shown on the virtual book 300 in FIG. 3A. In one embodiment, this tool bar is placed on the edge of the pages involved. On the tool bars (311 and 321), there are, for example, buttons for Bookmarking operation (312 and 322), Annotation operation (313 and 323) and Fit-to-page operation (314 and 324), Display-as-centerfold (315 and 325), Make-floating-page (316 and 326), Stop-Internet-transfer (317 and 327), Delete-page (318 and 328) as well as a URL field (316 and 326).

Clicking the “Bookmarking” button 312 on the left-hand tool bar 311 creates a page-bookmark 340 on the left-hand page 310. The page-bookmark 340 can be labeled accordingly with text, color, number or other kinds of information. Clicking the “Annotation” button 313 on the left-hand tool bar 311 creates an annotation box 332 on the left-hand page 310 as well as an associated annotation-bookmark 343. The user can enter any text, sound, or video annotation into the annotation box 332 and the corresponding annotation-bookmark 343 can be labeled accordingly. The finger-bookmarks 345 are created when the browsing book is used in conjunction with a browsing device (U.S. Pat. No. 5,909,207, Browsing System and Method for Computer Information) that sends a signal to indicate that the user has placed a temporary “finger” onto this page to bookmark this page so that later using the controls on the browsing device he can rapidly return to this page.

Similar types of bookmarks (the page-bookmarks (340-342 and 350-352), the annotation-bookmarks (343, 344, 353, 354), and the finger-bookmarks (345, 346, 355, 356)) are grouped close together and/or are distinguished by colors, texts, or other mechanisms to so that they can be easily distinguished.

The keyword-bookmarks 305, 306, 307, 308 are created when one clicks on a keyword, for example the word “mouse” 334, on the right-hand page 320. The pages marked by the keyword-bookmarks 305-308 are pages that contain information related to “mouse” 334 that have been linked to it. Text, color, or other markings on the keyword-bookmarks 305-308 can be used to indicate the nature of the information present on those correspondingly marked pages (e.g., whether the information is a definition of the keyword involved, a detailed description of the keyword, some other related concepts, etc.)

The user can select any of the bookmarks (340-346, 350-356, and 305-308) and activate them to jump to any desired page rapidly. When a page is selected and jumped to, the thickness between the current page and the destination page is displayed and shown to move across the computer screen as in the case of jumping to a desired page in a physical book.

Selection and activation (with a mouse cursor and clicking of a mouse button, for example) of the “Fit-to-page” button 314 on the left hand page 310 converts the left hand page, for example an HTML file that extends beyond the boundaries of the left hand page, into, for example an image file that fits within the boundaries of the left hand page, and fits it onto the left hand page. The button 324 on the right hand page operates similarly.

Selection and activation of the “Display-as-centerfold” button 315 on the left hand page 310 converts the left hand page contents 330 to occupy both pages 310 and 320, as shown in the Display-as-centerfold mode 395.

Selection and activation of the “Make-floating-page” button on the left hand page 316 creates a separate window 360 from the browsing book and displays the contents of the left hand page 330 in the window 360. The button 326 on the right hand page 320 operates in a similar fashion.

Selection and activation of the “Stop-Internet-transfer” button on the left hand page 317 terminates the transfer of Internet information onto that page. The button 327 on the right hand page operates in a similar fashion.

Selection and activation of the “Delete-page” button on the left hand page 318 deletes the contents of the entire left hand page from the virtual book 300. The rest of the contents on the other pages are shifted to fill in the blank space/page left behind by the delete operation. The button 328 on the right hand page operates in a similar fashion.

When a URL (Universal Resource Locator) is entered into the URL field 319 on the left hand page 310 and activated, the contents to which the URL points is brought into the virtual book and placed at a specified location. The button 329 on the right hand page 320 operates in a similar fashion.

In summary, in the process of browsing information in a virtual book 100, a reader has a lot of freedom to move among the pages and information in the book 100 using a variety of navigational methods described in FIGS. 1-3 (e.g., by flipping the pages, by activating hyperlinks, or by using various kinds of bookmarks). In a typical browsing session of the virtual book 100, the reader's reading pattern can be characterized by a number of parameters. Firstly, there is the order of browsing through the pages—i.e. which page is looked-at first, followed by which other pages, etc. Secondly there is the time spent on the pages—how much time the reader spent in reading or browsing particular pages. Thirdly, which specific parts of a page the reader looks at or spends certain amount of time reading the contents. This has three sub-parameters —the specific part of the page the user looks at, the sequence of moving from one part to another part (within a page or across pages), and the time spent on each part.

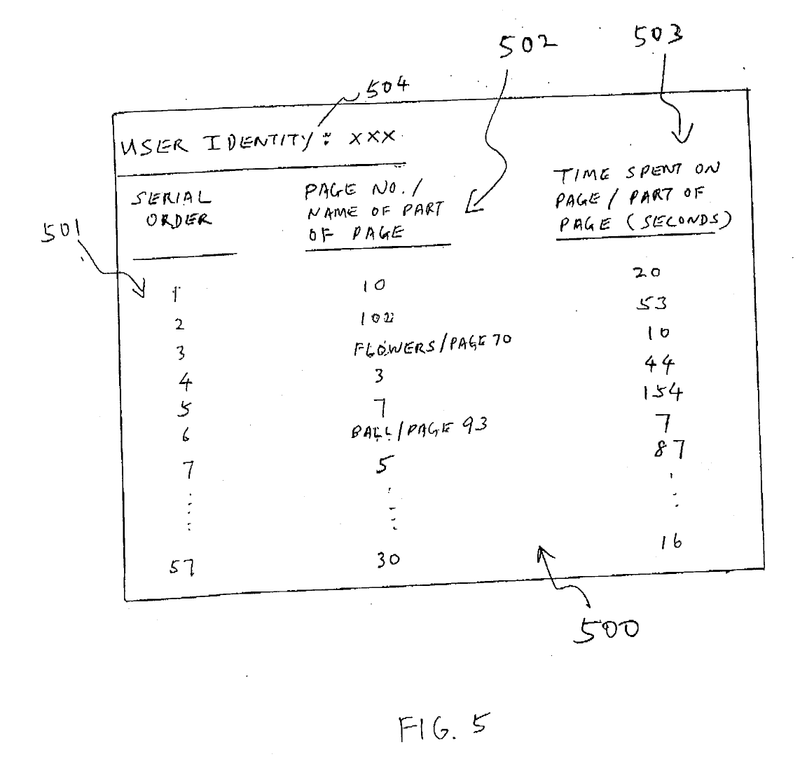

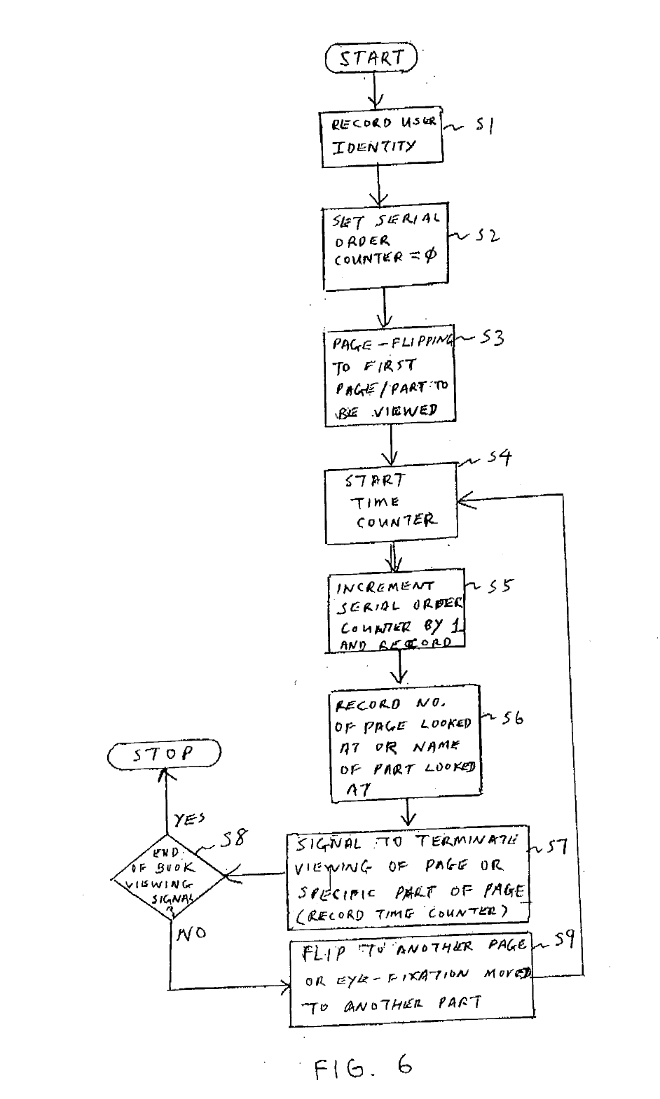

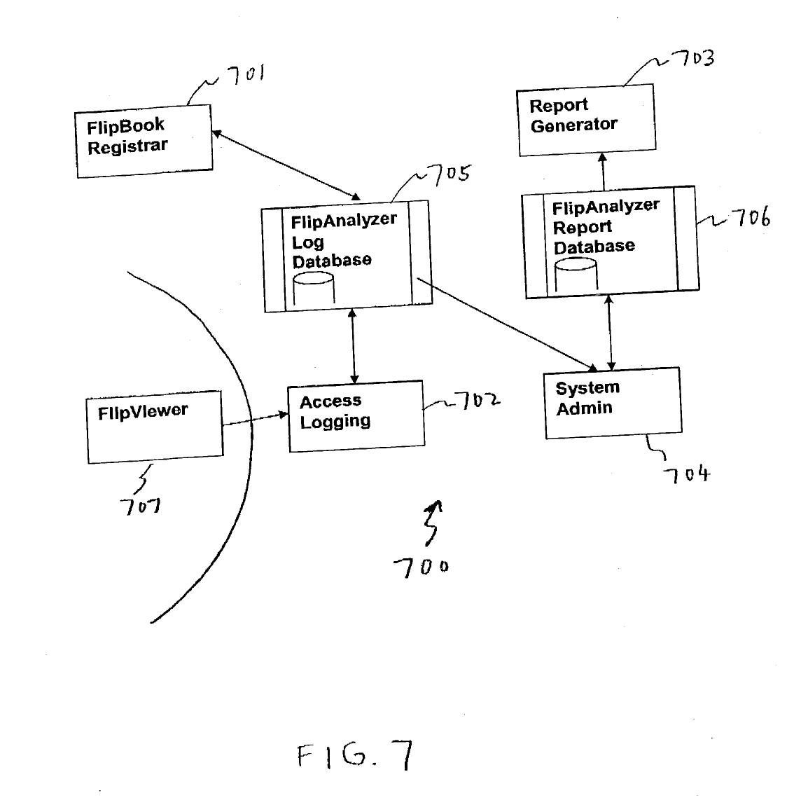

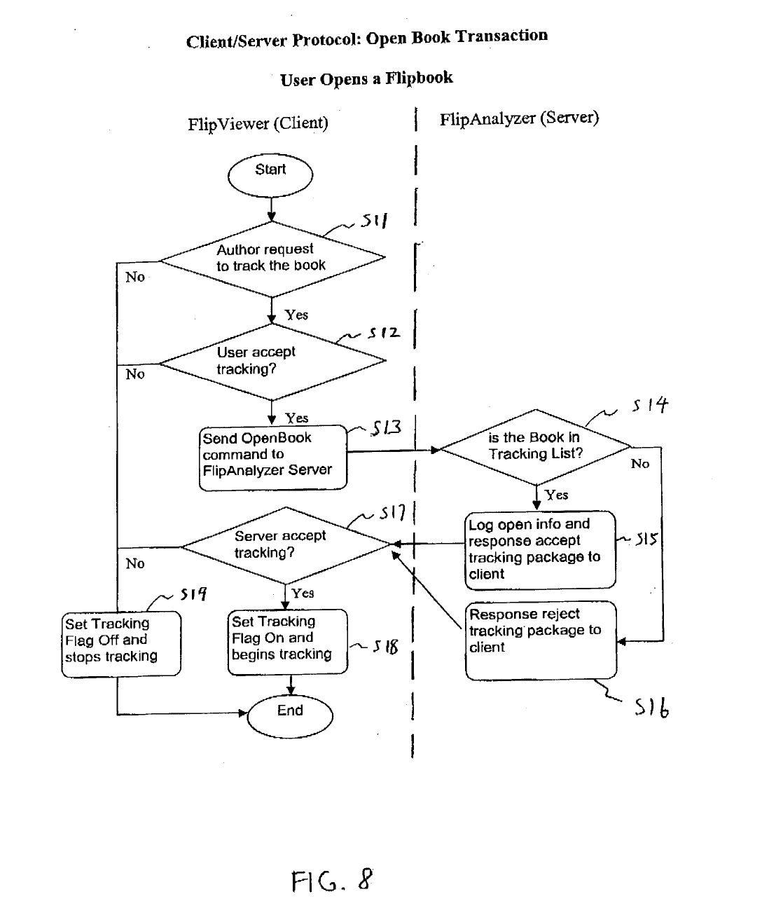

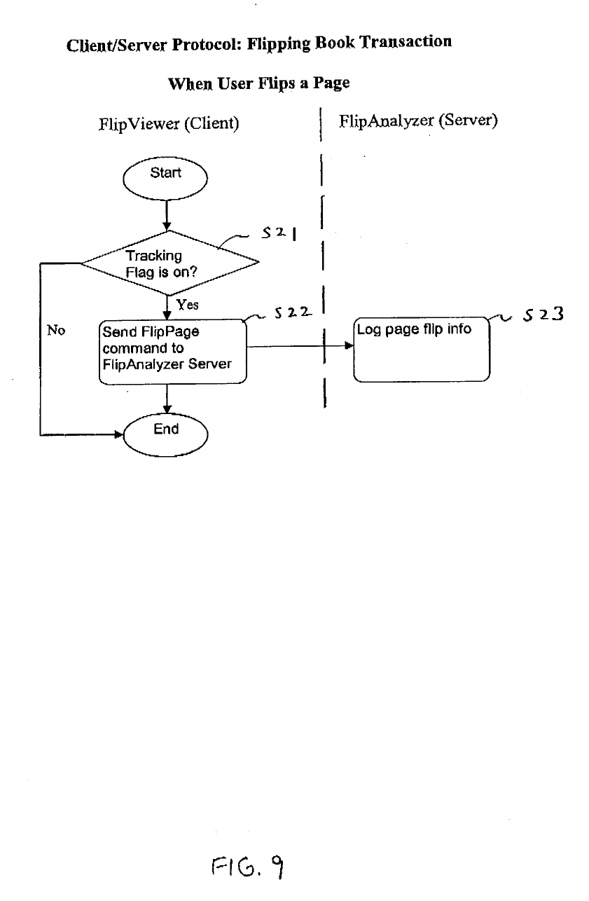

FIG. 4 shows an embodiment of a process by which the information on the reading pattern when a reader browsers a virtual book 400 can be transmitted through a channel 401 to a software 402 such that the reading pattern can be keep tracked of, displayed, analyzed and stored according to the present invention. The information can be displayed in a raw form 404 on a computer screen 403, or further analyzed (e.g., how often the reader returns to a certain page, what are the pages the reader spends more than 5 minutes on, etc.) The analyzing software 402 can also display the results of the analysis 404 on the computer screen 403. The raw data or analyzed data can be stored in a database 405 for subsequent retrieval.

A form of raw data 500 would be one in which, for each book viewing session (i.e., from opening of the book to closing of the book), the sequence of page access and time spent on these pages are directly recorded and displayed as shown in FIG. 5. This would consist of 1. The sequential order of access (501), 2. the page number or the name of the part of the page being looked at(502), and 3. the time spent on the corresponding page or the specific part of the page (503). FIG. 5. shows the raw data associated with a typical browsing session where the reader starts browsing the book from a certain page and finally exits the book at a certain page. The identity of the user 504 can also be recorded with each set of raw data 500.

All kinds of analyses can be performed on the raw data 500 to obtain more complicated statistical information on the reading process. At a coarse level, one can look at how long the total time spent on reading the book is. At a finer level, one can look at what pages are accessed more often, and which pages are seldom looked at. One can tabulate in detail the frequency at which each page is viewed. At some higher level, one can even extract information on the overall pattern of page access—e.g., first half of the book is always looked at first before proceeding to the second half. There are numerous other aspects of the book reading pattern that can be extracted from the raw data 500.

The channel 401 (FIG. 400) can be a process within a computer or across many computers and communication hardware (e.g., the Internet, an intranet, etc.). Therefore the reading pattern of a reader can be kept track of remotely.

Since the virtual book 400 is represented as a two-page spread, the software that generates the virtual book 400 can transmit information on which two pages the reader is currently looking at, but it is not able, by itself, to know which one of the two pages the reader is looking at, unless it is aided by other hardware or software. One method to achieve this is to use a eye-fixation tracking device (consisting perhaps of a camera trained on the eyes of the reader together with some eye-fixation analyzing software) that feeds the information of the eye-fixation pattern of the reader through the channel 401 to the analyzing software 402.

The same method can also be used to track which specific parts (e.g., 410, 411, 412) on the pages that the reader is looking at, and hence provides a higher resolution information on the reading pattern down to specific parts (410, 411, 412) of the pages in the virtual book 400.

The raw data 500 can be obtained and transmitted by the software that generates the virtual book 400 using a process shown in FIG. 6. The process starts at step S1, where the identity of the user is recorded (this could be the IP address of the user if he/she is on the Internet) and later recorder/transmitted as User Identity Data 504. The process then flows to step S2, where a serial order counter is reset to 0. Then, the process flows to step S3, where the page flipping command to the first page/part of the book to be viewed is sent to the virtual book 400 to flip to the first page/part of the book to be viewed. The process then flows to step S4, where a time counter is reset to begin tracking of the time spent on the page or a specific part of the page. The process then flows to step S5, where the serial order counter is incremented by 1 and its content is recorded, later to be transmitted as serial order data 501. Next, the process flows to step S6, where the page number currently in view or the name of the specific part of the page now being looked at is recorded and transmitted as Page Number/Name of Specific Part of Page Data 502. This information is obtained from, for example, the software generating the virtual book 400 itself as the software knows which page the reader has requested to flip to or from an eye-fixation hardware/software system that looks at the eye-fixation of the reader at a specific part of the displayed information.

The process then flows to step S7, where a signal is received that signifies the termination of viewing a page or a specific part of a page. The time counter started in step S4 is stopped and the time spent on viewing the page or a specific part of the page is recorded or transmitted as Time Spent on Page/Part of Page Data 503. The process then flows to step S8 to test if the signal received in step S7 is a signal to terminate the entire browsing process (i.e., to close the book). If so, the process stops. If not the process flows to step S9 in which the book is flipped to another page or the eye-fixation of the reader is moved to another part of a page. The process from step S9 then flow back to step S4 to start the time counter running for the next cycle.

The information (e.g., the raw data 500 or some data derived from it) on the reading pattern thus obtained through the method described in FIG. 4 can be used in a variety of ways. One way is to use this information to modify the contents and layout of the information in the book 400 either off-line or in real-time to achieve the maximum impact of information delivery. Suppose the pages in the virtual book 400 contains advertisements specifically targeted to impress certain information on the reader, another way the reading pattern information can be used is to gauge the effectiveness of these advertisements (e.g., the more time the reader spends on an advertisement, the more effective it is). This has important implication for Internet or electronic advertisement process as charges on advertisements can then be fine-tuned according to reading/browsing/viewing pattern. This is not possible in traditional paper book.

One embodiment of a “FlipAnalyzer/Server” system 700 that tracks users' access and use of virtual books is shown in FIG. 7. The system 700 logs user access information and generates reports for further analysis that includes, for example, 1. Access Log: who (user's IP address); when (date and time); what (virtual books, pages); 2. Time Spent On Viewing: the time user spends on reading a book and each page; and 3. Reading Pattern: page access by time.

There are four major modules (701, 702, 703, 704) in the FlipAnalyzer/Server system 700. FlipBook Registrar 701 is an administration module used to register a flipbook (virtual book) into the Log Database 705 before it can be tracked. Access Logging 702 is a logging module used to record user access log information in the database 705 for the purpose of reporting. The Report Generator module 703 creates reports in, for example, the HTML format for further analysis based on the data in the Report Database 706. The Systems Administration module 704 manages data collected and performs data archival and house keeping. The FlipViewer module 707 is the software that generates and displays the flipbook and its associated contents at the client end for the purpose of viewing and browsing the flipbook in a flipping format by the user/reader.

The information captured by the Access Logging module 702 includes user IP address, the time a registered flipbook (virtual book) is opened, the time a registered flipbook is closed, the time a page is flipped to, the reading/flipping pattern, etc. The data collected is kept on-line until it is archived. The Report Generator 703 generates dynamic tabular reports based on the on-line log records. The results of reporting can be in HTML format and the user can save the results for further analysis. Report data include 1. user IP address; 2. the time a flipbook is opened/closed; 3. time spent on each page; and 4. reading pattern (page access by time). The following types of report can be provided: 1. view by user; 2. view by date; 3. view by book; 4. summary report; 5. detailed report; etc.

A computer site running FlipViewer 707 has to be registered into the system 700 before a flipbook being viewed on the FlipViewer 707 on the site could be tracked. The FlipBook Registrar 701 provides function to handle the registration of a site running FlipViewer 707 based on its domain name or directory. The System Administration module 704 provides data backup of the report database, data archiving from log database to report database for the purpose of generating reports, and use login and access control.

FIG. 8 show the Client/Server Protocol for the Open Book Transaction when a user opens a virtual book (flipbook) according to one embodiment of the present invention. The process involved the communication between the FlipViewer (707) side and the FlipAnalyzer (700) side. The process starts at step S11 (on the FlipViewer 707 side) in which a check is made to determine whether the Author of the flipbook requests to track the flipbook. If the answer is “no”, the process then flows to step S19 in which a Tracking Flag is set to “Off” and the tracking is stopped. If the answer is “yes”, the process flows to step S12 in which a check is made to determine whether the User accepts the tracking of the flipbook. If the answer is “no”, the process flows to step S19 in which a Tracking Flag is set to “Off” and the tracking is stopped. If the answer is “yes”, the process flows to step S13 in which an OpenBook command is sent to the FlipAnalyzer Server 700. The process then flows to step S14 (on the FlipAnalyzer 700 side) to determine if the flipbook is in the Tracking List. If the answer is “yes”, the process flows to step S15 in which the open book information is logged and the response is to accept the tracking package to Client (i.e., the FlipViewer 707). If the answer is “no”, the process flows to step S16 in which the response is to reject the tracking package to Client 707. After both steps S15 and S16 on the FlipAnalyzer 700 side, the process flows to step S17 on the FlipViewer 707 side, in which a check is made to determine whether the Server 700 has accepted the tracking. If the answer is “no”, the process flows to step S19 in which the Tracking Flag is set to “Off”. If the answer is “yes”, the process flows to step S17 in which the Tracking Flag is set to “On” and the tracking begin. After step S18 or step S19 the process ends.

In step S13, the Client 707 sends OpenBook tracking command to FlipAnalyzer 700 in two parts (FIG. 8B). Part I is the Command “bOpen.cgi”, Part II is the Data consisting of fields OPF URL and OPF UID, which are the URL and the ID of the opened flipbook respectively. If the Server 700 accepts tracking, it returns the following responses in two parts in step S15. Part I is a Status, and “OK” is returned. Part II is Data in which the Timestamp of the Server 700 is returned to be used by Client (FlipViewer 707) to report subsequent timing of page flip and a Session Key is returned to uniquely identify an open book session. If the Server 700 rejects tracking, it returns the following response in step S16: Status: NO. (FIG. 8B)

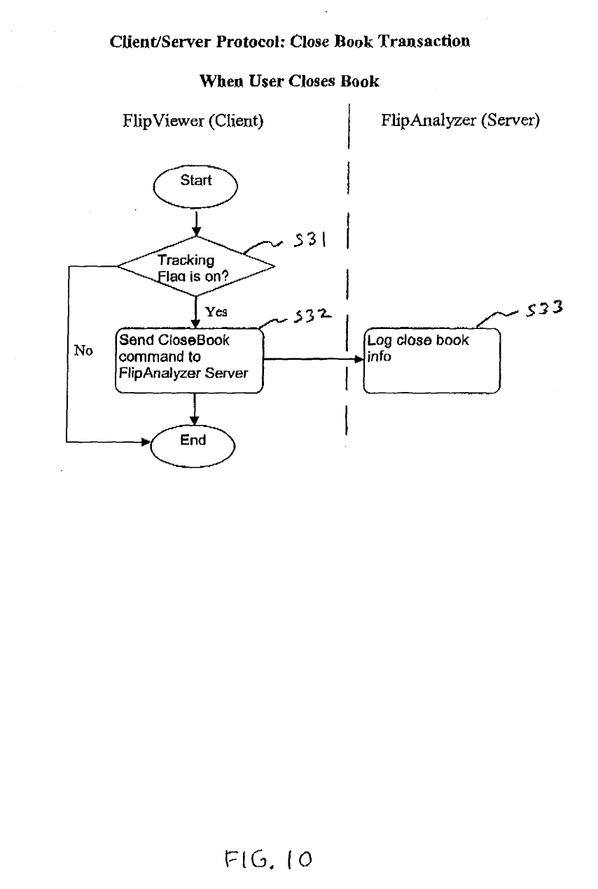

FIG. 9 shows the Client/Server Protocol for the Flipping Book Transaction when a user flips a page. The process starts at step S21 on the FlipViewer 707 side in which a check is made to determine whether the Tracking Flag is set to “On”. If the answer is “yes”, the process flows to step S22 in which a FlipPage command is sent to the FlipAnalyzer Server 700. If the answer is “no”, the process ends. After step S22, the process ends on the FlipViewer 700 side and it also flows to step S23 on the FlipAnalyzer 700 side in which the page flip information is logged.

In step S22, the Client 707 sends the FlipPage command to FlipAnalyzer/Server 700 in two parts. Part I is a Command: “bPage.cgi”. Part II is Data consisting of three parts. Part A is the Page URL. Part B is the Timestamp with reference to OpenBook Timestamp returned by Server 700. Part C is the Session Key to uniquely identify an open book session. (FIG. 9)

FIG. 10 shows the Client/Server Protocol for the Close Book Transaction when a user closes a book. The process starts at step S31 on the FlipViewer 707 side in which a check is made to determine whether the Tracking Flag is set to “On”. If the answer is “yes”, the process flows to step S32 in which a CloseBook command is sent to the FlipAnalyzer Server 700. If the answer is “no”, the process ends. After step S32, the process ends on the FlipViewer 700 side and it also flows to step S33 on the FlipAnalyzer 700 side in which the close book information is logged.

In step S32, the Client 707 sends the CloseBook command to FlipAnalyzer/Server 700 in two parts. Part I is a Command: “bClose.cgi”. Part II is Data consisting of three parts. Part A is the OPF UID (ID of the flipbook). Part B is the Timestamp with reference to OpenBook Timestamp returned by Server 700. Part C is the Session Key to uniquely identify an open book session. (FIG. 10)

Based on this protocol, data such as that described in FIG. 5 can be collected, displayed and stored by the Server 700.

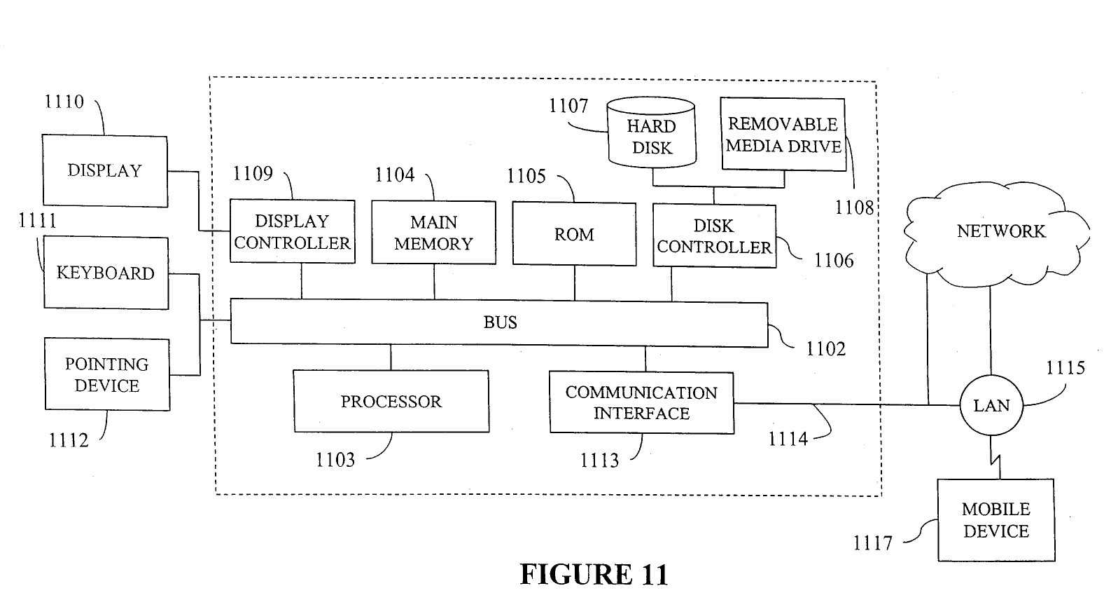

FIG. 11 illustrates a computer system 1101 upon which an embodiment of the present invention may be implemented. The computer system 1101 includes a bus 1102 or other communication mechanism for communicating information, and a processor 1103 coupled with the bus 1102 for processing the information. The computer system 1101 also includes a main memory 1104, such as a random access memory (RAM) or other dynamic storage device (e.g., dynamic RAM (DRAM), static RAM (SRAM), and synchronous DRAM (SDRAM)), coupled to the bus 1102 for storing information and instructions to be executed by processor 1103. In addition, the main memory 1104 may be used for storing temporary variables or other intermediate information during the execution of instructions by the processor 1103. The computer system 1101 further includes a read only memory (ROM) 1105 or other static storage device (e.g., programmable ROM (PROM), erasable PROM (EPROM), and electrically erasable PROM (EEPROM)) coupled to the bus 1102 for storing static information and instructions for the processor 1103.

The computer system 1101 also includes a disk controller 1106 coupled to the bus 1102 to control one or more storage devices for storing information and instructions, such as a magnetic hard disk 1107, and a removable media drive 1108 (e.g., floppy disk drive, read-only compact disc drive, read/write compact disc drive, compact disc jukebox, tape drive, and removable magneto-optical drive). The storage devices may be added to the computer system 1101 using an appropriate device interface (e.g., small computer system interface (SCSI), integrated device electronics (IDE), enhanced-IDE (E-IDE), direct memory access (DMA), or ultra-DMA).

The computer system 1101 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1101 may also include a display controller 1109 coupled to the bus 1102 to control a display 1110, such as a cathode ray tube (CRT), for displaying information to a computer user. The computer system includes input devices, such as a keyboard 1111 and a pointing device 1112, for interacting with a computer user and providing information to the processor 1103. The pointing device 1112, for example, may be a mouse, a trackball, or a pointing stick for communicating direction information and command selections to the processor 1103 and for controlling cursor movement on the display 1110. In addition, a printer may provide printed listings of data stored and/or generated by the computer system 1101.

The computer system 1101 performs a portion or all of the processing steps of the invention in response to the processor 1103 executing one or more sequences of one or more instructions contained in a memory, such as the main memory 1104. Such instructions may be read into the main memory 1104 from another computer readable medium, such as a hard disk 1107 or a removable media drive 1108. One or more processors in a multi-processing arrangement may also be employed to execute the sequences of instructions contained in main memory 1104. In alternative embodiments, hard-wired circuitry may be used in place of or in combination with software instructions. Thus, embodiments are not limited to any specific combination of hardware circuitry and software.

As stated above, the computer system 1101 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1101, for driving a device or devices for implementing the invention, and for enabling the computer system 1101 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1103 for execution. A computer readable medium may take many forms, including but not limited to, non-volatile media, volatile media, and transmission media. Non-volatile media includes, for example, optical, magnetic disks, and magneto-optical disks, such as the hard disk 1107 or the removable media drive 1108. Volatile media includes dynamic memory, such as the main memory 1104. Transmission media includes coaxial cables, copper wire and fiber optics, including the wires that make up the bus 1102. Transmission media also may also take the form of acoustic or light waves, such as those generated during radio wave and infrared data communications.

Various forms of computer readable media may be involved in carrying out one or more sequences of one or more instructions to processor 1103 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1101 may receive the data on the telephone line and use an infrared transmitter to convert the data to an infrared signal. An infrared detector coupled to the bus 1102 can receive the data carried in the infrared signal and place the data on the bus 1102. The bus 1102 carries the data to the main memory 1104, from which the processor 1103 retrieves and executes the instructions. The instructions received by the main memory 1104 may optionally be stored on storage device 1107 or 1108 either before or after execution by processor 1103.

The computer system 1101 also includes a communication interface 1113 coupled to the bus 1102. The communication interface 1113 provides a two-way data communication coupling to a network link 1114 that is connected to, for example, a local area network (LAN) 1115, or to another communications network 1116 such as the Internet. For example, the communication interface 1113 may be a network interface card to attach to any packet switched LAN. As another example, the communication interface 1113 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1113 sends and receives electrical, electromagnetic or optical signals that carry digital data streams representing various types of information.

The network link 1114 typically provides data communication through one or more networks to other data devices. For example, the network link 1114 may provide a connection to a another computer through a local network 1115 (e.g., a LAN) or through equipment operated by a service provider, which provides communication services through a communications network 1116. In preferred embodiments, the local network 1114 and the communications network 1116 preferably use electrical, electromagnetic, or optical signals that carry digital data streams. The signals through the various networks and the signals on the network link 1114 and through the communication interface 1113, which carry the digital data to and from the computer system 1101, are exemplary forms of carrier waves transporting the information. The computer system 1101 can transmit and receive data, including program code, through the network(s) 1115 and 1116, the network link 1114 and the communication interface 1113. Moreover, the network link 1114 may provide a connection through a LAN 1115 to a mobile device 1117 such as a personal digital assistant (PDA) laptop computer, or cellular telephone. The LAN communications network 1115 and the communications network 1116 both use electrical, electromagnetic or optical signals that carry digital data streams. The signals through the various networks and the signals on the network link 1114 and through the communication interface 1113, which carry the digital data to and from the system 1101, are exemplary forms of carrier waves transporting the information. The processor system 1101 can transmit notifications and receive data, including program code, through the network(s), the network link 1114 and the communication interface 1113.

While particular embodiments of the present invention have been illustrated and described, it will be appreciated that numerous changes and modifications will occur to those skilled in the art, and it is intended that the appended claims cover all those changes and modifications which fall within the spirit and scope of the present invention.

Obviously numerous modifications and variations of the present invention are possible in light of the above teachings. It is therefore to be understood that within the scope of the appended claims, the invention may be practiced otherwise than specifically described herein.

What is claimed is:

1. A method for analyzing a reading pattern of a reader of an electronic document, comprising:
gathering a datum of the reading pattern of an electronic document, said electronic document having flipping pages;
storing the datum in a storage medium;
retrieving the datum from the storage medium; and
at least one of displaying the datum retrieved from the storage device and analyzing the datum retrieved from the storage device, said step of analyzing the datum configured to produce an analysis result.

2. The method of claim 1, wherein said analyzing step comprises:
analyzing the datum to produce at least one of the following results,
a time the electronic document was opened by the reader;
a time the electronic document was closed by the reader;
a total time spent by the reader viewing the said electronic document;
a sequence of opening and viewing pages of the electronic document by the reader;
a time when the reader flipped to each page of the electronic document;
a time when the reader flipped away from each page of the electronic document;
a total time spent by the reader viewing each page of the electronic document;
a total time spent by the reader reading a left page of the electronic document;
a total time spent by the reader reading a right page of the electronic document;
a time when viewing a predetermined portion of an individual page of the electronic document is started by the reader;
a time when viewing the predetermined portion of an individual page of the electronic document is terminated by the reader; and
a total time spent by the reader viewing the predetermined portion of an individual page of the electronic document.

3. The method of claim 1, wherein said retrieving step comprises:
sending the datum to a remote computing device.

4. The method of claim 1, wherein said step of at least one of displaying and analyzing the datum comprises:
displaying the datum on at least one of a computer display and a television screen.

5. The method of claim 1, wherein said step of retrieving the datum and said step of at least one of displaying the datum and analyzing the datum respectively comprise:
retrieving the datum from the storage device by a remote computing device; and
at least one of displaying and analyzing the datum retrieved from the storage device at the remote computing device.

6. The method of claim 1, further comprising a step of:
sending an alert from a monitoring device to at least one of an internal and an external analysis device.

7. The method of claim 6, wherein said sending step comprises:
sending an alert corresponding to at least one of the following conditions, a time when the electronic document is opened by the reader;
a time when the electronic document is closed by the reader;
a time when the reader flipped to each page of the electronic document;
a time when the reader flipped away from each page of the electronic document;
a time when a predetermined portion of an individual page of the electronic document is being looked at by the reader; and
a time when the predetermined portion of an individual page is no longer being looked at by the reader.

8. The method of claim 7, wherein said step of at least one of displaying and analyzing comprises:
at least one of displaying and analyzing the alert, said step of analyzing the alert configured to produce at least one of the following results, a time the electronic document was opened by the reader;
a time the electronic document was closed by the reader;
a total time spent by the reader viewing the said electronic document;
a sequence of opening and viewing pages of the electronic document by the reader;
a time when the reader flipped to each page of the electronic document;
a time when the reader flipped away from each page of the electronic document;
a total time spent by the reader viewing each page of the electronic document;
a total time spent by the reader reading a left page of the electronic document;
a total time spent by the reader reading a right page of the electronic document;
a time when viewing a predetermined portion of an individual page of the electronic document is started by the reader;
a time when viewing the predetermined portion of an individual page of the electronic document is terminated by the reader; and
a total time spent by the reader by the predetermined portion of an individual page of the electronic document.

9. The method of claim 1, further comprising a step of:
selecting by the reader one of a consent-to-be-monitored status and a no-consent-to-be-monitored status.

10. A system for analyzing a reading pattern of a reader of an electronic document, comprising:
means for gathering a datum of the reading pattern of an electronic document, said electronic document having flipping pages;
means for storing the datum in a storage medium;
means for retrieving the datum from the storage medium; and
means for at least one of displaying the datum retrieved from the storage device and analyzing the datum retrieved from the storage device, said step of analyzing configured to produce an analysis result.

11. The system of claim 10, wherein said means for at least one of displaying and analyzing comprises:
means for at least one of displaying and analyzing the datum to produce at least one of the following results,
a time the electronic document was opened by the reader;
a time the electronic document was closed by the reader;
a total time spent by the reader viewing the said electronic document;
a sequence of opening and viewing pages of the electronic document by the reader;
a time when the reader flipped to each page of the electronic document;
a time when the reader flipped away from each page of the electronic document;
a total time spent by the reader viewing each page of the electronic document;
a total time spent by the reader reading a left page of the electronic document;
a total time spent by the reader reading a right page of the electronic document;
a time when viewing a predetermined portion of an individual page of the electronic document is started by the reader;
a time when viewing the predetermined portion of an individual page of the electronic document is terminated by the reader; and
a total time spent by the reader viewing the predetermined portion of an individual page of the electronic document.

12. The system of claim 10, wherein said means for retrieving comprises:
means for sending the datum to a remote computing device.

13. The system of claim 10, wherein said means for at least one of displaying and analyzing comprises:
means for displaying the datum on at least one of a computer display and a television screen.

14. The system of claim 10, wherein said means for retrieving and said means for at least one of displaying and analyzing respectively comprise:
means for retrieving the datum from the storage device by a remote computing device; and
means for at least one of displaying and analyzing the datum retrieved from the storage device at the remote computing device.

15. The system of claim 10, further comprising:
means for sending an alert from a monitoring device to at least one of an internal and an external analysis device.

16. The system of claim 15, wherein said means for sending comprises:
means for sending an alert corresponding to at least one of the following conditions,
a time when the electronic document is opened by the reader;
a time when the electronic document is closed by the reader;
a time when the reader flipped to each page of the electronic document;
a time when the reader flipped away from each page of the electronic document;
a time when a predetermined portion of an individual page of the electronic document is being looked at by the reader; and
a time when the predetermined portion of an individual page is no longer being looked at by the reader.

17. The system of claim 16, wherein said means for at least one of displaying analyzing comprises:
means for at least one of displaying and analyzing the alert, said means for analyzing the alert configured to produce at least one of the following results,
a time the electronic document was opened by the reader;
a time the electronic document was closed by the reader;
a total time spent by the reader viewing the said electronic document;
a sequence of opening and viewing pages of the electronic document by the reader;
a time when the reader flipped to each page of the electronic document;
a time when the reader flipped away from each page of the electronic document;
a total time spent by the reader viewing each page of the electronic document;
a total time spent by the reader reading a left page of the electronic document;
a total time spent by the reader reading a right page of the electronic document;
a time when viewing a predetermined portion of an individual page of the electronic document is started by the reader;
a time when viewing the predetermined portion of an individual page of the electronic document is terminated by the reader; and
a total time spent by the reader viewing the predetermined portion of an individual page of the electronic document.

18. The system of claim 10, further comprising:
means for selecting by the reader one of a consent-to-be-monitored status and a no-consent-to-be-monitored status.

19. A system for analyzing a reading pattern of a reader of an electronic document, comprising:
a datum gathering device configured to gather a datum of the reading pattern of an electronic document, said electronic document having flipping pages;
a datum storage device configured to store the datum retrieved by the datum gathering device in a storage medium;
a datum retrieving device configured to retrieve the datum from the storage medium; and
at least one of a datum display device and a datum analysis device, said datum analysis device configured to analyze the datum retrieved from the storage medium to produce an analysis result.

20. The system of claim 19, wherein said datum analysis device comprises:
an analysis component configured to produce at least one of the following results,
a time the electronic document was opened by the reader;
a time the electronic document was closed by the reader;
a total time spent by the reader viewing the said electronic document;
a sequence of opening and viewing pages of the electronic document by the reader;
a time when the reader flipped to each page of the electronic document;
a time when the reader flipped away from each page of the electronic document;
a total time spent by the reader viewing each page of the electronic document;
a total time spent by the reader reading a left page of the electronic document;
a total time spent by the reader reading a right page of the electronic document;
a time when viewing a predetermined portion of an individual page of the electronic document is started by the reader;
a time when viewing the predetermined portion of an individual page of the electronic document is terminated by the reader; and
a total time spent by the reader viewing the predetermined portion of an individual page of the electronic document.

21. The system of claim 19, wherein the datum retrieving device comprises:
an datum sending device configured to send the datum retrieved by the datum storage device to a remote computing device.

22. The system of claim 19, wherein said at least one of display device and an analysis device comprises:
at least one of a computer display and a television screen.

23. The system of claim 19, wherein said datum retrieving device and said datum analysis device respectively comprise:
a remote computing device retrieval module; and
a remote computing device analysis module.

24. The system of claim 19, further comprising:
an alert sending device configured to send an alert from a monitoring device to at least one of an internal and an external analysis device.

25. The system of claim 24, wherein said alert sending device comprises:
an alert sending device configured to send an alert corresponding to at least one of the following conditions,
a time when the electronic document is opened by the reader;
a time when the electronic document is closed by the reader;
a time when the reader flipped to each page of the electronic document;
a time when the reader flipped away from each page of the electronic document;
a time when a predetermined portion of an individual page of the electronic document is being looked at by the reader; and
a time when the predetermined portion of an individual page is no longer being looked at by the reader.

26. The system of claim 25, wherein said at least one of a datum display device and a datum analysis device comprises:
at least one of a datum display device configured to display the alert and a datum analysis device configured to analyze the alert to produce at least one of the following results,
a time the electronic document was opened by the reader;
a time the electronic document was closed by the reader;
a total time spent by the reader viewing the said electronic document;
a sequence of opening and viewing pages of the electronic document by the reader;
a time when the reader flipped to each page of the electronic document;
a time when the reader flipped away from each page of the electronic document;
a total time spent by the reader viewing each page of the electronic document;
a total time spent by the reader reading a left page of the electronic document;
a total time spent by the reader reading a right page of the electronic document;
a time when viewing a predetermined portion of an individual page of the electronic document is started by the reader;
a time when viewing the predetermined portion of an individual page of the electronic document is terminated by the reader; and
a total time spent by the reader viewing the predetermined portion of an individual page of the electronic document.

27. The system of claim 19, further comprising:
a consent-to-be-monitored device configured to enable the reader to select one of a consent-to-be-monitored status and a no-consent-to-be-monitored status.

28. A computer program product, comprising:
computer instructions configured to enable one or more computing devices to perform the method of claims 1-9.
